(19) United States
(12) Patent Application Publication
(10) Pub. No.: US 2025/0042288 A1
(43) Pub. Date: Feb. 6, 2025

(54) ELECTRIC VEHICLE ENERGY MANAGEMENT SYSTEM AND METHOD

(71) Applicant: FUSION ENERGIE INC., Laval (CA)

(72) Inventors: Daniel Sarrazin, Laval (CA); Amel Zerigui, Montréal-Nord (CA)

(21) Appl. No.: 18/787,940

(22) Filed: Jul. 29, 2024

Related U.S. Application Data
(60) Provisional application No. 63/516,575, filed on Jul. 31, 2023.

(51) Int. Cl. B60L 53/63; B60L 53/62; B60L 53/66

(52) U.S. Cl. CPC B60L 53/63; B60L 53/62; B60L 53/66

(57) ABSTRACT

An electric vehicle energy management system is provided for controlling the demand charge of a plurality of chargers connected to a service entry providing a fixed maximum power. The portion of the maximum power available to distribute to the chargers is computed to determine a deployment parameter. Based on the deployment parameter and on the number of chargers connected to a vehicle, a diversity parameter is computed. If the available power is sufficient and the diversity parameter is low, a control signal is transmitted authorizing the chargers to operate at maximum capacity. If the available power is insufficient, the chargers are authorized to operate below their maximum capacity based on the available power. If the diversity parameter is too high, the power is distributed among the chargers based on the number of connected chargers or on the battery state of the connected vehicles, to lower the diversity parameter.

### CROSS-REFERENCE TO RELATED APPLICATION

This application claims the benefit of and priority to U.S. Provisional Patent Application No. 63/516,575, filed Jul. 31, 2023, and entitled “ELECTRIC VEHICLE ENERGY MANAGEMENT SYSTEM AND METHOD”, the disclosure of which is hereby incorporated by reference in its entirety.

### TECHNICAL FIELD

The technical field relates to electrical power distribution, and more specifically to systems and methods for controlling demand charge of a plurality of electric vehicle supply equipment connected to an electric circuit having an electric service entry providing a fixed maximum power.

### BACKGROUND

The popularity of electric vehicles (EV) is on the rise, and therefore so is the need for Electric Vehicle Supply Equipment (EVSE), also known as charging stations. Most existing electric services for buildings were set up based on electric load calculations in accordance with design requirements at the time of construction and thus, did not take EVSE into account. Because EVSE have a heavy current draw, with level-2 EVSE typically having a power draw at least 7.6 kW, installing EVSE in an existing building usually requires upgrading the electrical service to a higher amperage and/or installing an electric vehicle energy management system (EVEMS—also referred to as a demand charge controller) that controls the power that can be drawn by EVSE at any given time.

An EVEMS can be installed between the electric service entry and the main electric panel, or between the main electric panel and the EVSE. The EVEMS monitors power consumption and controls the power made available to EVSE to avoid circuit overloading.

EVEMS can implement different strategies for monitoring and controlling power consumption. For example, one common method is known as load-switching. In this method, when the monitored circuit load is below a threshold, the EVEMS allows the EVSE to draw power at the EVSE's nominal rating. When the load moves above the threshold, the controller cuts out power to the EVSE. The threshold, sometimes called “trip value”, can be based on a safety ratio of the current load and the maximum available current.

Existing load-switching EVEMS are typically not aware of the battery status of an EV, whether or not the EV is actually connected to the EVSE. Moreover, load-switching EVEMS are generally not able to modulate the charging rate of a vehicle connected to the EVSE. As such, existing load-switching EVEMS are not well adapted to manage the sharing of available power between a plurality of EVSE.

There is therefore a need for an improved EVEMS that is better adapted to manage a plurality of connected EVSE.

### SUMMARY

In an aspect, an electric vehicle energy management system (EVEMS) for controlling demand charge of a plurality of electric vehicle supply equipment (EVSE) connected to an electric circuit having a common electric service entry providing a fixed maximum power to the electric circuit is provided. The EVEMS includes at least one communication device, configured to allow for bidirectional communications between the EVEMS and each of the plurality of EVSE, at least one processor and memory, a power computation module, a state data acquisition module, and a power distribution module. The power computation module is configured to compute, using the at least one processor a portion of the fixed maximum power corresponding to an available power to distribute among the plurality of EVSE, and a deployment parameter corresponding to an indication of a number of the plurality of EVSE that can operate according to a given operating condition based on the available power. The state data acquisition module is configured to receive, by the at least one communication device, from each of the plurality of EVSE, state data including at least an indication of whether the corresponding EVSE is connected to an electric vehicle (EV), and store, to the at least one memory, the received state data. The power distribution module is configured to compute, by the at least one processor, a diversity parameter corresponding to a ratio between a number of EV-connected EVSE and the deployment parameter, distribute the available power among the EVSE based at least in part on the deployment parameter.

In some embodiments, the power distribution module is configured to: determine whether the available power is sufficient to power all the EV-connected EVSE according to the given operating condition; in response to determining that the available power is sufficient and that the diversity parameter is below a predetermined threshold, send, by the at least one communication device, a control signal to the plurality of EVSE authorizing each EVSE to operate according to the given operating condition; in response to determining that the available power is insufficient, distribute the available power among the EVSE by sending a control signal to the EVSE authorizing each EVSE to operate below the given operating condition according to the available power; and in response to determining that the diversity parameter is above the predetermined threshold, send a control signal to distribute the available power among the EVSE as a function of the number of EV-connected EVSE and/or based on a battery state of the EV connected to the EVSE, to bring the diversity parameter below the predetermined threshold.

In another aspect, a method for controlling demand charge of a plurality of electric vehicle supply equipment (EVSE) connected to a common electric service entry providing a fixed maximum power to an electric circuit is provided. The method includes, at an electric vehicle energy management system (EVEMS), computing a least a portion of the fixed maximum power corresponding to an available power to distribute among the plurality of EVSE, computing a deployment parameter indicating a number of the plurality of EVSE that can operate according to a given operating condition based on the available power, receiving, from each of the plurality of EVSE, state data including at least an indication of whether the corresponding EVSE is connected to an electric vehicle (EV), computing a diversity parameter corresponding to a ratio between a number of EV-connected EVSE and the deployment parameter, determining whether the available power is sufficient to power the EV-connected EVSE, and distributing the available power among the EVSE based at least in part on the deployment parameter.

In some embodiments distributing the available power among the EVSE includes: determining whether the available power is sufficient to power all the EV-connected EVSE according to the given operating condition; in response to determining that the available power is sufficient and that the diversity parameter is below a predetermined threshold, sending a control signal to the plurality of EVSE authorizing each EVSE to operate according to the given operating condition; in response to determining that the available power is insufficient, distributing the available power among the EVSE by sending a control signal to the EVSE authorizing each EVSE to operate below the given operating condition according to the available power; and in response to determining that the diversity parameter is above the predetermined threshold, sending a control signal to distribute the available power among the EVSE as a function of the number of EV-connected EVSE and/or based on a battery state of the EV connected to the EVSE, to bring the diversity parameter below the predetermined threshold.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 in a schematic of an electric circuit comprising an EVEMS in accordance with an embodiment.

FIG. 2 in a flowchart of a method for controlling demand charge of a plurality of EVSE using an EVEMS, in accordance with an embodiment.

FIG. 3 is a schematic of a recurrent neural network usable by an EVEMS in accordance with an embodiment.

FIG. 4 is a schematic of a Long Short-Term Memory cell usable in a recurrent neural network in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

One or more systems described herein may be implemented at least in part in computer program(s) executed on processing device(s), each comprising at least one processor, a data storage system (including volatile and/or non-volatile memory and/or storage elements), and optionally at least one input and/or output electronic device. “Processing devices” encompass computers, servers and/or specialized electronic devices which receive, process and/or transmit data. As an example, “processing devices” can include processing means, such as microcontrollers, microprocessors, and/or CPUs, or be implemented on FPGAs. For example, and without limitation, a processing device may be a programmable logic unit, a mainframe computer, a server, a personal computer, a cloud-based program or system, a laptop, a personal data assistant, a cellular telephone, a smartphone, a wearable device, a tablet, a video game console or a portable video game device.

Each program is preferably implemented in a high-level programming and/or scripting language, for instance an imperative e.g., procedural or object-oriented, or a declarative e.g., functional or logic, language, to be interpretable by a computer system. However, a program can be implemented in assembly or machine language if desired. In any case, the language may be a compiled or an interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is, of course, chosen according to the desired use, whether it should retain instructions, or temporarily store, retain or update data. Steps of the proposed method are implemented as software instructions and algorithms, stored in computer memory and executed by processors.

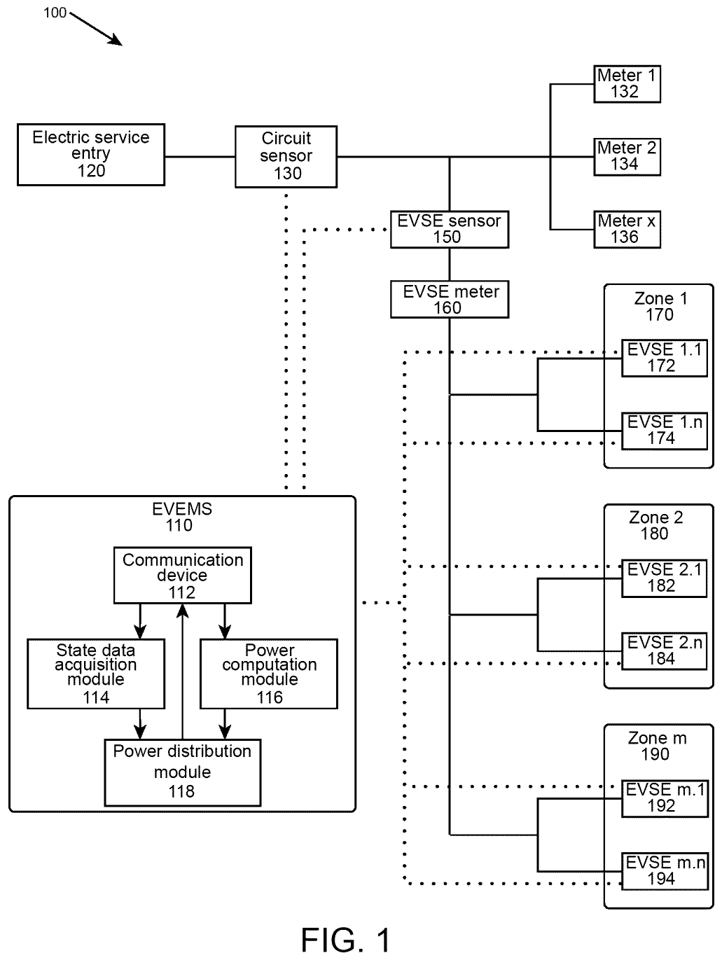

With reference to FIG. 1, an exemplary system 100 for controlling the demand charge of a plurality of EVSE connected to an electric circuit having a common electric service entry with an EVEMS is shown. Broadly described, the system 100 comprises an electric circuit receiving power from an electric service entry 120 and distributing this power to a number of subcircuits, including main subcircuits having main circuit breakers each associated with a corresponding utility meter 132, 134, 136, and an EVSE subcircuit having at least one EVSE circuit breaker with a corresponding utility meter 160. An EVEMS 110 can direct power flowing in the EVSE subcircuit to a number of EVSE 172, 174, 182, 184, 192, 194. The power received from the electric service entry 120 and/or distributed to the subcircuits can correspond to alternating current (AC) or direct current (DC).

In an embodiment, the electric circuit can be the electric circuit of multi-dwelling unit and/or office building, receiving power from an electric service entry 120, and distributing this power to main subcircuits such as units of a multi-dwelling unit building or floors of an office building. In some embodiments, at least one main subcircuit can be used to provide power to common areas, such as entrance halls, stairways, elevators and indoor and/or outdoor parking lots. EVSE subcircuit can be used to service a number of EVSE 172, 174, 182, 184, 192, 194. This subcircuit can be provided with its own utility meter 160 for measuring consumption separately from other subcircuits. A circuit sensor 130 can be provided at a point between the electric service entry 120 and the first branching, principal branching and/or electrical deployment root of the circuit to measure the total load of the electric circuit (including the load of main subcircuits and EVSE subcircuit). Additionally, a load sensor can be provided at each main circuit breaker, such that the total electric load of the circuit is the sum of the load measures by each sensor. An EVSE sensor 150 can also be provided to measure the total electric load on a branch feeding all the EVSE and/or on one or more branches each corresponding to a zone including a portion of the EVSE. Alternatively or additionally, a load sensor can be provided on a number of branches each feeding a number of EVSE, such that the total EVSE electric load is the sum of the load measures by each sensor.

In some embodiments, the EVSE subcircuit can be split into a number of zones 170, 180, 190, each zone corresponding for instance to a parking lot, a floor of a parking lot, or a sector of a parking lot. In some embodiments, each one of these zones can have the same number of EVSE, whereas in other embodiments the number of EVSE can vary from one zone to another.

As can be appreciated, the electric service entry 120 of a building can have a predetermined capacity, i.e., it is configured to provide a fixed maximum power or current to the circuit. For example, the electric service entry 120 can be configured to supply a maximum current of 1600 A, corresponding 384 kW at 240 V. The capacity is usually determined based on estimated needs at building time. Needs can change over time, though. As examples, installing a network of EVSE, adding new industrial machines, or changing the heating or air conditioning system can cause an additional load that exceeds the capacity. While this problem can in theory be resolved by replacing the electric service entry with one having a higher capacity or installing an additional electric service entry, this is not always possible in practice. Even when it is, there is a high cost and inconvenience associated with doing so. It is therefore advantageous to install load management systems capable of controlling the demand charge of electric apparatuses, in particular apparatuses that have fluctuating demands such as EVSE, industrial machines, and heating or air conditioning systems.

As an example, system 100 can provide an EVEMS 110 configured to measure the electric load at one or more points within the electric circuit connected to an electric service entry and perform computations to determine suitable operating parameters of a plurality of EVSE, including controlling the power that each EVSE is authorized to draw.

The EVEMS 110 can include a communication device 112, configured to send, receive or exchange information with relevant equipment, including for instance load sensors and/or EVSE. Communication device 112 can implement one or more means of data exchange, including for instance wired, e.g., over a local area network using IP or MSTP, or wireless means of communication, e.g., over a wireless local area network using Wi-Fi™, and/or using Zigbee™, Bluetooth™, Z-Wave™, RFID or other suitable Internet of Things (IoT) protocols and/or cellular networks. The communication device 112 can be configured to exchange data with EVSE using for instance an Open Charge Point Protocol (OCPP), e.g., OCPP 1.6 and/or OCPP 2.0, an Open Automated Demand Response Protocol, and/or an IEEE 2030.5 protocol, or other protocols that allow bidirectional communication between the EVEMS and the relevant equipment such as the load sensors and/or EVSE.

The EVEMS 110 can further include a state data acquisition module 114, configured to receive state data from connected equipment, e.g., EVSE, for instance through the communication device 112. As examples, the state data received from each EVSE can include one, any or all of whether an electric vehicle (EV) is connected to EVSE, the time at which and/or the duration for which the EV was connected to the EVSE, the EV battery capacity, the remaining EV battery capacity, an EV battery state, e.g., a battery health condition indication, a rated load of the EVSE, a current charging state of the battery, a current power draw of the EVSE, and/or any type of data from the EVSE.

Once acquired, the state data can be stored in persistent and/or volatile memory for use by the other modules of the EVEMS 110. In some embodiments, the state data acquisition module 114 can include a storage submodule including a database with a structure optimized to increase the performance of the state data acquisition module 114 when storing and manipulating state data and/or to model complex relationships among the state data. The database can for instance be implemented using a graph database such as an RDF store that can be manipulated or searched using a query language such as SPARQL or using a relational database management system (RDBMS) that can be manipulated or searched using a query language such as SQL, or a combination of multiple technologies.

As an example, the state data can be used to determine a number of EV-connected EVSE, i.e., a number of EVSE having an EV connected thereto. The total number of EV-connected EVSE can be determined across the entire electric circuit, or across a predefined zone 170, 180, 190 of the electric circuit. Given an electric circuit including a subcircuit dedicated to EVSE divided into M zones, with each zone including N EVSE, the state data can be used to compute a deployment matrix D, corresponding to an M×N logical matrix in which each entry corresponds to an EVSE, D_{m,n} corresponding to the nth EVSE in zone m. In such a matrix, the value D_{m,n} indicates whether the corresponding EVSE has an EV connected to it. The value D_{m,n} can, for example, correspond to a binary value where 0 indicates that no EV is connected, and 1 indicates that an EV is connected. In such an embodiment, calculating a sum of all D_{m,n} values in the matrix, e.g.,

$${\sum }_{\begin{matrix}i = 1 \\ j = 1\end{matrix}}^{m , n} {D}_{i , j}$$

can provide the total number of EV-connected EVSE represented in the deployment matrix.

As a further example, historical state data, i.e., state data that was acquired in the past over a suitable period of time, can be used to compute the energy used by each EVSE, for instance over an electricity billing period, such that the EVEMS 110 can further be used to bill the appropriate fraction of the total energy consumed in the electric circuit to the appropriate user.

The EVEMS 110 can further include a power computation module 116, configured to compute a number of power distribution parameters. For instance, the power computation module 116 can use the capacity of the electric service entry 120 as well as the capacity of each main circuit breaker in order to determine available power to be distributed to EVSE through the EVSE subcircuit. In some embodiments, the available power to be distributed is obtained by subtracting the combined capacity of the main circuit breakers from the fixed maximum power provided by electric service entry 120. In some embodiments, a safety factor is applied, for instance to the fixed maximum power or to the result of the subtraction, to determine the available power that can safely be distributed to EVSE. The safety factor can for instance correspond to a prescription from an electrical code, e.g., the National Electrical Code™, the Canadian Electrical Code or the IEC 60364 standard.

As can be appreciated, the voltage on the electric circuit is constant. Accordingly, since P=VI, the power available to distribute among EVSE can be calculated in terms of current (i.e., amperage A). As an example, the current available for distribution to EVSE Aₐ can correspond to Aₐ=(A_{c}×80%)−Aₘ, where A_{c} represents the maximum current that can be supplied by the electric entry, Aₘ is the sum of current in the main subcircuits, and 80% is the safety factor. For example, if the electric service entry 120 is configured to supply a maximum of 1600 A, and all branches of the electric circuit draw a total of 850 A, the current available for distribution to EVSE can be calculated as Aₐ=(1600 A×80%)−850 A=430 A.

The power distribution parameters can be computed based at least in part on load data received from load sensors positioned throughout the circuit. In an embodiment, a first load sensor 130 can be provided between the electric service entry 120 and the main subcircuits. This load sensor 130 can be configured to measure current that is drawn across the entirety of the electric circuit. When deploying EVEMS, the parameter Aₘ can be obtained by taking an initial measurement using first load sensor 130 to measure the sum total of current drawn by the main subcircuits. In an embodiment, a second load sensor 150 can be provided between the first load sensor 130 and the EVSE subcircuit. This load sensor 150 can be configured to measure the current that is drawn only by the EVSE subcircuit. The parameter Aₘ can be calculated in real time, for example, by measuring the total current drawn by the entire electric circuit using first load sensor 130, and subtracting from that the current drawn only by the EVSE subcircuit as measured by second load sensor 150.

The maximum number of EVSE that can actively charge will be limited by the current available for distribution Aₐ. The maximum number of EVSE that can operate optimally (i.e., operate at their full charging capacity) will depend on how much current is available to be distributed to operate the EVSE at their maximum charging capacity. Similarly, the maximum number of EVSE that can operate (i.e., operate at any capacity) will depend on how much current is available to be distributed to operate the EVSE at their minimum charging capacity. The maximum and minimum charging capacity can, for example, be defined according to the type of EVSE and/or can be defined by an electrical code. As an example, the electrical code can require a 30 A maximum charging capacity for each EVSE (corresponding to approx. 7.2 kW at 240 V), and a minimum charging capacity of 8 A (corresponding to approx. 2 kW at 240 V).

Accordingly, once the available power to be distributed has been computed, the power computation module 116 can further compute a deployment parameter that represents a number of EVSE that can operate according to a given operating condition. For example, the deployment parameter can correspond to a maximum deployment parameter MD that represents a maximum number of EVSE that can operate optimally (i.e., operate at their full charging capacity). In some embodiments, all EVSE managed by the EVEMS can have the same full charging capacity, also called maximum capacity. In these embodiments, the maximum deployment parameter can be calculated by dividing the current available for distribution Aₐ by the maximum capacity common to all the EVSE, i.e., it can be defined as the quotient of the available power by a predetermined maximum capacity corresponding to the common maximum capacity. As an example, if the electrical code requires 30 A for each EVSE (corresponding to approx. 7.2 kW at 240 V) and the current available for distribution Aₐ is 750 A, the maximum deployment parameter MD can be calculated as MD=750 A/30 A=25. As such, a total of 25 EVSE may be able to operate at their maximum capacity subject to the available power. As explained above, the MD parameter provides an indication of how many EVSE can operate at maximum capacity. It can be appreciated that all EVSE need not have the same maximum capacity. In some embodiments, EVSE exhibit charging limit variability. In some of these embodiments, the MD calculation can be performed by calculating the quotient of the available current by a predetermined maximum capacity corresponding to the EVSE with the highest maximum capacity managed by the EVEMS. In other of these embodiments, the MD calculation can be parametrized by the maximum capacity of each individual EVSE. For example, a first component of the MD parameter can be calculated based on a number of EVSE with a maximum charging capacity of 30 A, whereas a second component of the MD parameter can be calculated based on a number of EVSE with a maximum charging capacity of 48 A. Further components can be calculated for EVSE with other maximum charging capacities. In some embodiments, the MD parameter is configurable such that it can be calculated at installation of the EVEMS and/or changed from time to time. As an example, the MD can be calculated when a new EVSE is installed and/or is to be managed by the EVEMS, and/or when an existing EVSE is removed and/or ceases to be managed by the EVEMS.

Although a maximum deployment parameter MD was described above, it is appreciated that deployment parameters can be calculated for different operating conditions. For example, a minimum deployment parameter can be computed, for instance to determine how many EVSE can operate at minimum capacity. As an example, if the electrical code requires a minimum charging capacity of 8 A and 750 A are available for distribution, [750 A/8 A]=93 EVSE may be able to operate at minimum capacity subject to the available power. As can be appreciated, the minimum deployment parameter (and/or any other type of deployment parameter) can also be parametrized based on the individual charging capacities of different EVSE, and can be calculated at installation and/or changed from time to time following the installation or removal of an EVSE as described above.

As mentioned above, the electric circuit can include a subcircuit dedicated to EVSE divided into M zones. Each zone can be assigned a corresponding maximum number of EVSE that can operate at maximum capacity. For example, where the subcircuit is divided into one zone (i.e., M=1), a deployment parameter MD of 25 would indicate that the one zone can have up to 25 EVSE available to operate at maximum capacity. As another example, where the subcircuit is divided into two zones (i.e., M=2), a deployment parameter MD of 25 would indicate that that the two zones together can have up to 25 EVSE available to operate at maximum capacity. Assuming a uniform distribution between zones, the first zone can have up to 12 EVSE available to operate at maximum capacity, and the second zone can have up to 13 EVSE available to operate at maximum capacity. As a further example where a subcircuit is divided into five zones (i.e., M=5), a deployment parameter MD of 25 would indicate that the five zones together can have up to 25 EVSE available to operate at maximum capacity and, assuming a uniform distribution, each zone can have up to 5 EVSE available to operate at maximum capacity. It is appreciated that where multiple zones are provided, the distribution of the available EVSE need not be uniform and can be configured as needed.

The EVEMS can further include a power distribution module 118, configured to distribute power among the EVSE according to varying needs of users. In particular, the power distribution module 118 can be configured to determine power that each EVSE should be authorized to draw in accordance with real time and historical state data acquired by the state data acquisition module 114 and the power distribution parameters computed by the power computation module 116.

In an embodiment, the power distribution module 118 can be configured to calculate a diversity parameter D representative of the distribution of available charging capacity as a function of the maximum number of EVSE that can operate according to a given operating condition. The diversity parameter D can be calculated by dividing the number of EVSE that currently have an EV connected thereto (e.g., as reported in real time by the data acquisition module 114) by the deployment parameter. As an example, the diversity parameter D can be calculated to represent the distribution of available charging capacity as a function of the maximum number of EVSE that can operate at their full charging capacity (i.e. that can operate optimally). In such an example, the diversity parameter D can be calculated by dividing the number of EV-connected EVSE by the maximum deployment parameter MD. If the deployment parameter MD is calculated as 25, and there are a total of 14 EVSE that currently have an EV connected thereto, the diversity parameter can be calculated as D=17/25=0.68. As another example, if the deployment parameter MD is calculated as 25, and there are a total of 34 EVSE that currently have an EV connected thereto, the diversity parameter can be calculated as D=40/25=1.6.

As can be appreciated, there are two relevant ranges for the diversity parameter. The diversity parameter can be less than or equal to 1, or the diversity parameter can be greater than 1. When the diversity parameter is less than or equal to 1, the capacity for optimal charging has not been exceeded, whereas when the diversity parameter is greater than 1, the capacity for optimal charging has been exceeded. In some embodiments, the diversity parameter can be limited to a maximum. In particular, where a building code imposes a minimum charging capacity for all EVSE connected to the circuit, the maximum number of EVSE that can possibly be connected to the circuit while respecting the code may make it such that a maximum diversity cannot be exceeded. For example, where a building code imposes a maximum charging capacity of 6.2 kW per EVSE and a minimum charging capacity of 2 KW per EVSE, the maximum diversity can be 3, as shown by way of example in the table below.

| | Maximum Number | Maximum Number |
|---|---|---|
| Available Power | of Optimal EVSE | of EVSE |
| (kW) | (diversity = 1) | (diversity = 3) |
| 200 | 32 | 100 |
| 180 | 29 | 90 |
| 160 | 25 | 80 |
| 140 | 22 | 70 |
| 120 | 19 | 60 |
| 100 | 16 | 50 |

The power distribution module 118 can also be configured to determine in real time whether there is sufficient power available to distribute among the EVSE, or if all the available power has been distributed. As an example, in the present embodiment, a measurement can be taken using the second load sensor 150 to determine the real time current being consumed by the EVSE subcircuit. If the measured current is less than Aₐ, it can be determined that there is sufficient power available to distribute among the EVSE. If the measured current is greater than or equal to Aₐ, it can be determined that all available power has been distributed and/or that there is insufficient power available to distribute.

As can be appreciated, the power distribution module 118 can be configured to distribute power among the EVSE based on whether the deployment parameter D is above or below a predetermined threshold of 1, and whether or not there is sufficient power available to distribute.

If the diversity parameter D is below the predetermined threshold and there is sufficient available power to distribute, the power distribution module 118 can transmit to all EV-connected EVSE, for instance via the communication device 112, a control signal authorizing each EV-connected EVSE to operate at its maximum capacity, i.e., to draw power and/or current up to its rated power and/or current.

If there is insufficient power to distribute, the power distribution module 118 can transmit to the EV-connected EVSE, for instance, via the communication device 112, control signals authorizing at least some of the EV-connected EVSE to operate below their predetermined capacity, i.e., to authorize the EVSE to draw power and/or current that is below its rated power and/or current and is suitable in view of the available power and/or current, for a period of time. The authorized power for each EVSE and corresponding durations can be determined according to the available power and the number of EV-connected EVSE that require power. As such, the power distribution module 118 can cause available power to be distributed as a function of the number of EV-connected EVSE. The authorized power can also be determined as a function of other parameters of the EV-connected EVSE, such as a battery state, a battery capacity, or a remaining battery capacity associated with each EV-connected EVSE. In some embodiments, the authorized power can be determined to allow power to be distributed among the EV-connected EVSE in a non-uniform manner based on predicted user behaviour and/or based on power distribution conditions defined by an administrator of the EVEMS 110. In some embodiments, if the diversity parameter D is above the predetermined threshold and there is insufficient power to distribute, the power can be distributed based on predicted user behaviour in order to drive the diversity parameter D down below the predetermined threshold.

If the diversity parameter D is above the predetermined threshold and there is sufficient available power to distribute the power distribution module 118 can transmit to the EV-connected EVSE, for instance via the communication device 112, control signals authorizing at least some of the EV-connected EVSE to operate below their predetermined capacity, i.e., to authorize the EVSE to draw power and/or current that is below its rated power and/or current and is suitable in view of the available power and/or current for a period of time. The authorized power for each EVSE and corresponding durations can be determined according to predicted user behaviour in order to drive the diversity parameter D down below the predetermined threshold. As explained above, all EVSE need not have the same maximum capacity. In some embodiments, given EVSE with different maximum capacities, the power distribution module 118 can be configured to take advantage of the charging limit variability of EVSE by sending a control signal to only a subset of the EVSE, having a higher maximum capacity, to operate below their predetermined capacity. As an example, when a first subset of the EVSE has a first maximum capacity, e.g., of 30 A, and a second subset of the EVSE has a second maximum capacity which is greater than the first maximum capacity, e.g., of 48 A, the power distribution module 118 can be configured to send a control signal to the second subset of EVSE to operate at the first maximum capacity. In some embodiments, this strategy can be combined with the other defined strategies. In some embodiments, this strategy can be prioritized, such that when applying this strategy is sufficient to drive the diversity parameter D down below the predetermined threshold, no other strategy is applied.

In embodiments where one or more power distribution conditions are defined, for instance by an administrator of the EVEMS 110, the power distribution module 118 can distribute the available power and/or current in such a way as to respect and/or obey the conditions. One, some or all the conditions can correspond to commands received from an energy service provider servicing the electric service entry 120, for instance through communication device 112, or to commands corresponding to conditions specified, e.g., in an energy contract. As an example, a condition can correspond to a demand response command, whereby an energy service provider indicates that load is to be reduced for a specified time period, e.g., from a first given time to a second given time on specified days or every day, and/or whenever the outdoor air temperature at a specified location is below and/or above one or more specified thresholds. One, some or all the conditions can correspond to orders received from one or more users of the EVEMS 110. As an example, a condition can correspond to an emergency user order, whereby a user indicates that they require a level of priority allowing them to charge their EV battery faster. As another example, a condition can correspond to a peak demand circumvention order, whereby a user indicates that they require charging their EV battery even if doing so requires infringing another condition, e.g., a demand response command. Other possible conditions can include but are not limited to, for instance: minimizing peak load, power and/or current; minimizing charging time; and obeying regulatory requirements. In embodiments with zones 170, 180, 190, additionally or alternatively, zone-related conditions can be defined. As examples, zone-related conditions can include distributing the available power to one, some or all of the zones, for instance, with the goal of minimizing peak power and/or of minimizing charge time.

In embodiments where power is distributed according to predicted user behaviour, the power distribution module 118 can distribute the available power based on predicted demand, schedule and/or durations associated with each EVSE. As an example, predicted demand, schedule and/or durations can include a forecast, for a given time period, e.g., the next 24 hours, of when and for how long each EVSE will be operating. In some embodiments, the power distribution module 118 can include a machine learning model trained to predict demand, schedule and/or durations associated with each EVSE. For instance, the power distribution module 118 can be configured to select a machine learning model based on a desired set of conditions, e.g., maximizing the number of operating EVSE and/or minimizing peak demand, and/or provide the desired set of conditions as an input of the machine learning model, provide state data as an input to the machine learning model, receive an output of the machine learning model including for instance predicted demand, a predicted schedule optimizing the desired set of conditions and/or predicted charging durations, e.g., for each EVSE, compute therefrom an authorized power and/or current draw for each EVSE, and send a control signal to each EVSE indicating its authorized draw.

It can be appreciated that a means of predicting charging demand, schedule and/or durations is to predict future state data from past state date, for instance using time series prediction methods. In some embodiments, the machine learning model can be trained to accept an input including a number of sequential sets of state data taken at equal or unequal time intervals, which can correspond to a time series, and/or to provide an output including one or more predicted states, a predicted schedule and/or one or more predicted charging durations over one point in time of a number of sequential points in time, which can correspond to a time series forecast. As an example, sets of state data collected over, e.g., the last 24 hours, the last month or the last year can be provided as input to the machine learning model, and/or the machine learning model can output a predicted schedule or predicted charging durations for each EVSE over, e.g., the next 24 hours, the next 48 hours or the next week.

Any suitable sequence machine learning model can be used. In some embodiments, the machine learning model can include one or more classical sequence machine learning model(s), including for instance an autoregressive model, a moving-average model, and/or an autoregressive-moving-average model. In some embodiments, the machine learning model can include one or more deep sequence machine learning model(s), e.g., deep autoregressive model(s), including for instance a recurrent neural network (RNN) model, such as a long short-term memory (LSTM) neural network model and/or a gated recurrent unit (GRU) neural network model, and/or a self-attentive model such as a transformer. Deep autoregressive models can advantageously be trained through self-supervised learning, reducing the resources required to train the machine learning model.

The EVEMS and the behaviour of users of charging stations define a complex non-linear system. The non-linearity can derive for instance from the variability of charging habits, which can be linked to random factors such as work schedules, daily commute and weather conditions. Therefore, traditional, linear models can produce predictions insufficiently accurate to capture the complex dynamics of such a system. In some embodiments, deep neural network models, such as deep autoregressive models, are used with non-linear activation functions to model the non-linearity of the system.

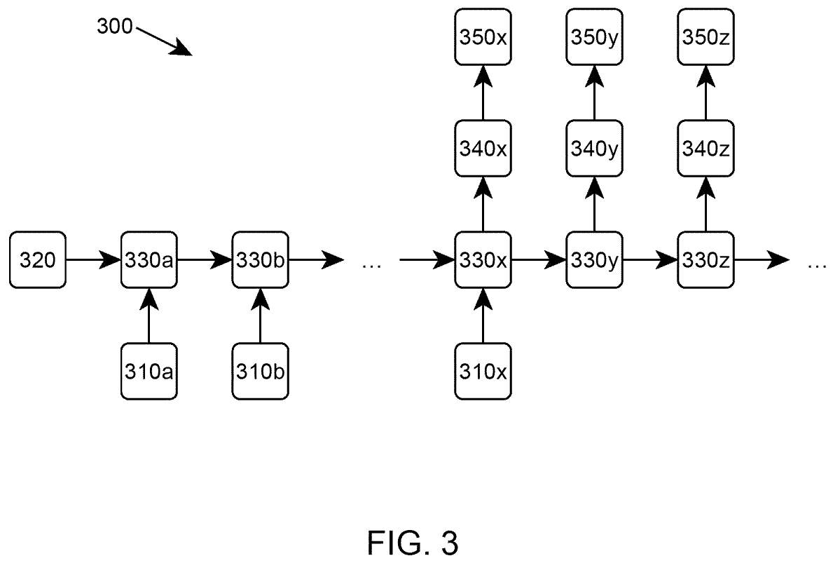

With reference to FIG. 3, an exemplary RNN 300 for implementing the machine learning model of a power distribution module 118 is shown in an unfolded representation. A number, predefined or not, of input nodes 310a-x, defining the input layer, sometimes represented as xₜ can be provided to receive state data at different timesteps. As an example, the RNN 300 can accept as a sequence of state data sets reflecting the state data at different points in time during a predefined period, e.g., the last 24 hours. The state data can be embedded into a suitable object, for instance a tensor of a suitable dimension. As an example, the state data of one given EVSE at one given point in time can be embedded into a vector, and the vectors corresponding to the state data of all the EVSE at the given point in time can be combined, e.g., by concatenation, to produce an augmented vector or a matrix, which can be provided to the input nodes 310a-x. In some embodiments, an embedding can additionally or alternatively be obtained by adding one or more embedding layers with learnt weights after the input layer.

Each input node 310a-x can be fed forward to a recurrent node of a first part of a hidden layer 330a-330x, sometimes represented as hₜ, forming a first part of a first hidden layer. The node hₜ can be said to encode a hidden state at time t. Each state node 330a-z can also be fed forward to a subsequent recurrent node, such that the output of a recurrent node hₜ can be a function of the output of both the corresponding input node xₜ and of preceding states h₀, h₁, . . . , hₜ₋₁. In some embodiments, an initial state 320, sometimes represented as door h₀ can be provided and fed forward as an initial state to the first recurrent node 330a, such that the output of hₜ can be a function of input node xₜ and of preceding states h₀, h₁, . . . , hₜ₋₁. A second part of the first hidden layer can correspond to nodes 330x-330z of which the output is fed, directly or indirectly through nodes of one or more additional hidden layers 340x-z, to output nodes 350x-z, in addition to being fed to the subsequent recurrent node. As an example, the RNN 300 can be configured output through its output nodes 350x-z a sequence of state data sets reflecting predicted state data at different points in time during a predefined period, e.g., the next 24 hours. In some embodiments, the RNN 300 can be configured to output only the next predicted state data from a sequence of previous state data. The next predicted data can then be added to the sequence of previous state data and fed back to the RNN to output subsequent state data in a recursive manner. In some embodiments, the RNN 300 can be configured to output additional or alternative information, including for instance a prediction, for each EVSE, of the time points and/or intervals during which they will be connected to an EV in need of charging during a predefined period, e.g., the next 24 hours. Zero, one or more hidden layers can be provided, including for instance recurrent layers such as SL™ layers and/or dense layers.

As shown in FIG. 3, the last input-receiving node 330x can both correspond to an input node 310x and to an output node 350x, forming part of both the first and second part of the first hidden layer. In some embodiments, though, the last input-receiving hidden node hₙ can be not directly or indirectly through one or more additional layers connected to an output node, and a subsequent, non-input-receiving state node, e.g., hₙ₊₁, can be connected to the first output node instead. In other embodiments, more than one node of the hidden layer can form part of both the first and the second part by being connected both to input and output nodes. In some embodiments, all the nodes of the hidden layer can form part of both the first and the second part by being connected both to input and output nodes.

While the RNN 300 is represented unfolded in FIG. 3, it will be appreciated that all recurrent nodes 330a-z can correspond to a single recurrent node with a hidden state that is updated at each timestep, using a linear or a nonlinear activation function or no activation function at all, and can correspond for instance to a vector comprising all the outputs of the node. It is known that using the recurrent node as just described can cause a vanishing and gradient exploding problem, with the potential effect that not all the available sequence of state data is efficiently used in predictions. This can be resolved by replacing the recurrent node with a unit performing more sophisticated state calculations, such as a LSTM unit or a GRU unit, and specifying one or more activation functions, for instance a hyperbolic tangent (tanh) activation function and/or a sigmoid recurrent activation function. It can be appreciated that neural networks hyperparameters known from different types of neural networks can be used in the recurrent layer, including for instance dropout and/or bias. It can be appreciated that alternative forms of RNNs can be used additionally or alternatively, including for instance stacked recurrent networks and bidirectional recurrent networks.

In some embodiments, the RNN model is an LSTM model. LSTM networks are particularly well suited for the type of data at stake because of their ability to remember information over long periods. They have “memory cells” (cell states) that allow them to retain and forget information as needed, thanks to regulatory gate mechanisms. This enables an LSTM model to capture consumption trends and patterns over different time scales.

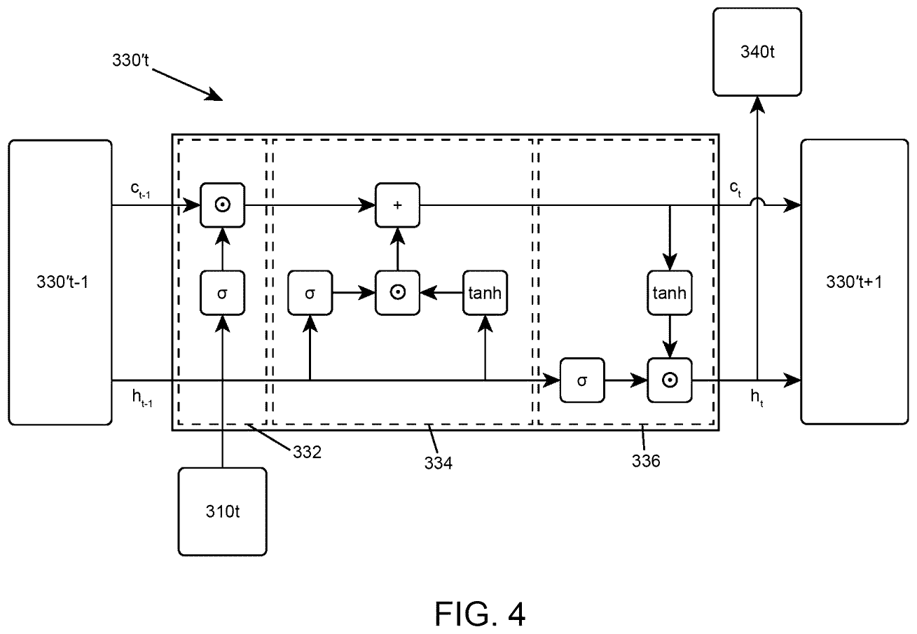

With reference to FIG. 4, an exemplary LSTM cell 330′t is shown. It can be appreciated that the recurrent node(s) 330a-z of the RNN can each correspond to an LSTM cell. The LSTM cell uses and updates a cell state, which can be said to implement long-term memory, preserving information throughout different stages of an inference task, while the hidden state implements short-term memory and is more directly impacted by the new inputs. The LSTM cell 330′t is configured to process at each time t an input symbol xₜ received from a preceding layer node 310t, based on a hidden state hₜ₋₁ and on a cell state cₜ₋₁ received from a preceding LSTM cell 330′t−1, to produce an output hidden state hₜ and cell state cₜ, for use by the subsequent LSTM cell 330′t+1. The new hidden state hₜ can also correspond to the output symbol sent to subsequent layer node 340t.

The LSTM cell 330′t can be divided into a plurality of gates, including a forget gate 332, an input gate 334, and an output gate 336.

The forget gate 332 is configured to allow for the removal of information from the cell state, for instance based on the hidden state and the input symbol. In some embodiments, the forget gate 332 computes an activation vector fₜ=σ(W_{f}[hₜ₋₁, xₜ]+b_{f}), where W_{f} is a weight vector learnt during training, [hₜ₋₁, xₜ] is a concatenation of hₜ₋₁ and xₜ, b_{f} is a learnt bias, and σ is a suitable function such as a sigmoid function. The vector fₜ can be applied to the cell state cₜ₋₁, for instance using an element-wise multiplication ⊙. Advantageously, the function can give a result comprised between 0 and 1, such that values close to 0 indicate that corresponding information should be mostly forgotten, and values close to 1 indicate that corresponding information should be mostly retained.

The input gate 334 is configured to allow for the addition of information to the cell state, for instance based on the hidden state and the input symbol. In some embodiments, the input gate 334 computes an activation vector iₜ=σ(Wᵢ[hₜ₋₁, xₜ]+bᵢ), where W; is a learnt weight vector, [hₜ₋₁, xₜ] is a concatenation of hₜ₋₁ and xₜ, b_{f} is a learnt bias, and σ is a suitable function such as a sigmoid function. In some embodiments, the input gate 334 computes a cell state update c̅ₜ=tanh (W_{c}[hₜ₋₁, xₜ]+b_{c}), where W_{c} is a learnt weight vector, [hₜ₋₁, xₜ] is a concatenation of hₜ₋₁ and xₜ, b_{c} is a learnt bias, and tanh is a suitable function such as a hyperbolic tangent function. The new cell state cₜ can be computed based on the vector fₜ, the vector iₜ and/or the cell state update c̅ₜ, for instance as cₜ=fₜ⊙cₜ₋₁+iₜ⊙c̅ₜ.

The output gate 336 is configured to update the hidden state, for instance based on the updated cell state, the previous hidden state and the input symbol. In some embodiments, the output gate 336 computes an activation vector oₜ=σ(Wₒ[hₜ₋₁, xₜ]+bₒ), where Wₒ is a learnt weight vector, [hₜ₋₁, xₜ] is a concatenation of hₜ₋₁ and xₜ, bₒ is a learnt bias, and σ is a suitable function such as a sigmoid function. The updated hidden state hₜ can then be computed by aggregating the vector oₜ with the updated cell state cₜ, for instance as hₜ=oₜ⊙ tanh (cₜ).

The machine learning model can be trained, i.e., optimal parameters such as weights and biases can be found, using a training set made of historical state data such as the state data stored in the state acquisition module 114. The training set can for instance be created by using a sliding window over the sequence of available historical state data. As an example, if the RNN inputs a time series corresponding to 24 hours of state data and outputs a time series corresponding to 24 hours of predicted state data, a window corresponding to 48 hours of state data can be used, with the first 24 hours being provided as input data and the subsequent 24 hours being provided as target data. In some embodiments, 24 hours can be provided as input data and only the subsequent set of state data can be provided as target data. In some embodiments, a preimplemented model fitting algorithm such as tensorflow.keras.Model.fit can be used, for instance with a tensorflow.keras.utils.Sequence object instance. Any suitable batch size can be used, such as an online batch size of 1, a full-batch size corresponding to the size of the training set, or a minibatch size greater than 1 and less than the size of the training set. A loss function, for instance a binary cross-entropy loss function, and an optimizer, for instance the Adam optimizer, can be used for gradient backpropagation. In some embodiments, a mean squared error function

$$L = \frac{1}{N} {\sum }_{i = 1}^{N} {( {y}_{i} - {\hat{y}}_{i} )}^{2}$$

is used, where N is the sample size, yᵢ is the real value at instant i, and ŷᵢ is the predicted value at instant i, and a backpropagation through time algorithm is used to update the parameters θ, for instance including the weights and the biases, with θ:=θ−γ∇_{θ}L, where γ is the learning rate and ∇_{θ}L is the loss gradient with respect to θ and L. Training can be performed for a set duration, over a set number of batches or epochs, or until a certain performance metric is achieved.

When compared to the suitable classical sequence machine learning models, the deep autoregressive machine learning models are advantageously more adaptable, more fault-tolerant, more noise-tolerant, and also faster at inference time. Advantageously, the sampling rate in, e.g., RNNs, used for time series forecasting can be adapted to available computing resources to ensure that the desired tradeoff between accuracy and efficiency can be obtained. As an example, if the machine training model is trained to make a 24-hour state data forecast from a 24-hour state data sequence, the timestep may be defined, e.g., as 1-hour to obtain a faster training and forecast or, e.g., as 1-minute to obtain slower training and forecasts but with better accuracy. As a tradeoff for their computational benefits, deep autoregressive machine learning models are not explainable and are probabilist, i.e., not deterministic.

It will be appreciated by persons skilled in the art that, alternatively to or in addition to the types of machine learning models described above, other types of machine learning algorithms and models can be adapted for use in the power distribution module 118, including for instance support vector machines, Gaussian process models, Bayesian network models, hidden Markov models, restricted Boltzmann machines, clustering-based models, and/or other generative or non-generative types of neural networks such as multilayer perceptrons, convolutional neural networks, deep stacking networks, variational autoencoders, energy-based models, and/or generative adversarial networks. It is understood that machine learning models, including neural network models, can be implemented using computer hardware elements, computer software elements or a combination thereof. Accordingly, the machine learning models described herein can be referred to as being computer-implemented. Various computationally intensive tasks related to the model can be carried out on one or more processors (central processing units and/or graphical processing units) of one or more programmable computers. For example, and without limitation, the programmable computer may be a programmable logic unit, a mainframe computer, server, personal computer, cloud-based program or system, laptop, personal data assistant, cellular telephone, smartphone, wearable device, tablet device, virtual reality device, smart display devices such as a smart TV, set-top box, video game console, or portable video game device, among others.

Once trained, the model has learnt to predict demand for each charging station based on historical data. At each instant t, the model can take recent, past consumption data as input and predict future consumption. This process can be repeated for each charging station. Once the individual needs of each station have been estimated, the predictions can be aggregated to generate an estimate of the overall demand for the whole EVEMS. This global estimate provides a better understanding of the energy consumption profile, and can for instance be used to identify peak and off-peak consumption periods.

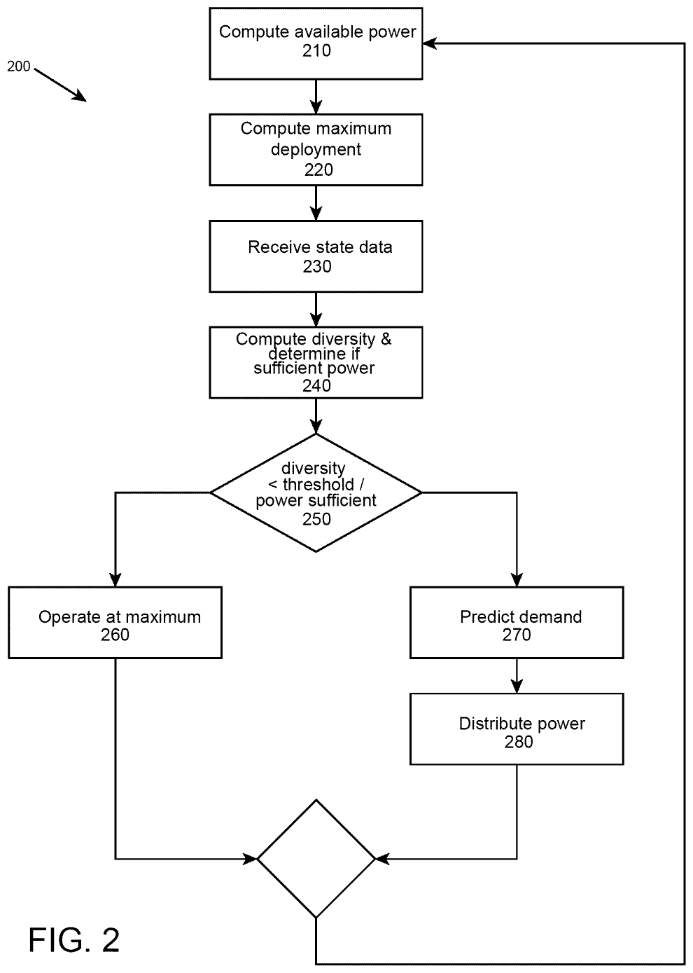

With reference to FIG. 2, an exemplary method 200 for distributing power to a plurality of devices, such as EVSE, is shown. The method can be carried out using the system 100 described above. Broadly described, the method 200 comprises performing measurements and calculations at steps 210-240 and, based on the result, either operating the devices at their maximum load 260 or distributing the available power 280 based on predicted demand to devices. Method 200 will be described particularly with respect to EVSE, but it is appreciated that the method can apply to distributing power to other devices with fluctuating demands, such as industrial machines, and heating or air condition systems, among others. Moreover, method 200 will be described in connection with a maximum deployment parameter MD, but it is appreciated that a similar method can apply using other deployment parameters.

A first step 210 can include computing at least a portion of a fixed maximum power that is available to be distributed among a plurality of EVSE. The fixed maximum power can, for instance, be calculated by an EVEMS communicating with load sensors located on an electrical circuit, and/or using a known value of the fixed maximum power that is provided by the electric service entry. In some embodiments, a predetermined safety factor can be applied, for instance, to ensure compliance with the applicable electrical code.

A subsequent step 220 can include computing a maximum deployment parameter MD. The parameter MD that represents a maximum number of EVSE that can operate optimally (i.e., operate at their full charging capacity). The maximum deployment parameter can be calculated by dividing the power available for distribution by the maximum capacity of each of the EVSE.

A step 230 can include receiving and storing state data from the EVSE, including an indication of whether an EV is currently connected to the EVSE (i.e., the EVSE is an EV-connected EVSE) and/or the charging state of the EV that is connected thereto.

A subsequent step 240 can include computing a diversity parameter D representative of the distribution of available charging capacity as a function of the maximum number of EVSE that can operate optimally. The diversity parameter D can be calculated by dividing the number of EVSE that currently have an EV connected thereto (e.g., as indicated by the state data) by the maximum deployment parameter MD.

A subsequent step 250 can include determining whether the diversity parameter D is below a predetermined threshold and whether there is sufficient power available to distribute among the EV-connected EVSE. As an example, it can be determined whether the diversity parameter D is below 1 . . . . As another example, it can be determined in real time whether there is sufficient power available to distribute among the EV-connected EVSE by using a load sensor to determine the real time current being consumed by the EVSE subcircuit, and determining whether the power available to distribute has been reached.

If it is determined that the diversity parameter D is below the threshold, step 260 can include sending a control signal to all the EV-connected EVSE, authorizing each EV-connected EVSE to operate at its maximum capacity.

If it is determined that the diversity parameter D is above the threshold, or it is determined that there is insufficient power available, subsequent steps 270 and 280 can be performed.

Step 270, can include predicting user behaviour, including the future demand for the EVSE, for instance using a trained machine learning model that accepts as input the state data obtained at step 230 over a certain time period, e.g., the last 24 hours, and gives as output predictions about which EVSE will require power and when over a certain time period, e.g., the next 24 hours.

A subsequent step 280 can include, based on the predictions performed at step 270, distributing the available power by determining which EVSE can operate at a given time and at what capacity, and sending a control signal to the relevant EVSE to authorize said EVSE to operate at the determined capacity. The available power can be distributed, for example, by causing at least some EVSE to operate below its predetermined maximum capacity. If there is insufficient power available to be distributed, the available power can be distributed as a function of the number of EV-connected EVSE at a given time. If the diversity parameter D is above the threshold, the power can be distributed using the predicted user behaviour in order to drive the diversity parameter D below the threshold.

In some embodiments, method 200 is constantly performed, in real time or near real time, or is performed once more as soon as the final step is completed, or is regularly performed at a set interval.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. An electric vehicle energy management system (EVEMS) for controlling demand charge of a plurality of electric vehicle supply equipment (EVSE) connected to an electric circuit having a common electric service entry providing a fixed maximum power to the electric circuit, the EVEMS comprising:
at least one communication device, configured to allow for bidirectional communications between the EVEMS and each of the plurality of EVSE;
at least one processor and memory;
a power computation module, configured to compute, using the at least one processor:
a portion of the fixed maximum power corresponding to an available power to distribute among the plurality of EVSE, and
a deployment parameter corresponding to an indication of a number of the plurality of EVSE that can operate according to a given operating condition based on the available power;
a state data acquisition module, configured to:
receive, by the at least one communication device, from each of the plurality of EVSE, state data comprising at least an indication of whether the corresponding EVSE is connected to an electric vehicle (EV), and
store, to the at least one memory, the received state data; and
a power distribution module, configured to:
compute, by the at least one processor, a diversity parameter corresponding to a ratio between a number of EV-connected EVSE and the deployment parameter,
distribute the available power among the EVSE based at least in part on the deployment parameter.

2. The EVEMS of claim 1, wherein the power distribution module is configured to:
determine whether the available power is sufficient to power all the EV-connected EVSE according to the given operating condition;
in response to determining that the available power is sufficient and that the diversity parameter is below a predetermined threshold, send, by the at least one communication device, a control signal to the plurality of EVSE authorizing each EVSE to operate according to the given operating condition;
in response to determining that the available power is insufficient, distribute the available power among the EVSE by sending a control signal to the EVSE authorizing each EVSE to operate below the given operating condition according to the available power; and
in response to determining that the diversity parameter is above the predetermined threshold, send a control signal to distribute the available power among the EVSE as a function of the number of EV-connected EVSE, and/or based on a battery state of the EV connected to the EVSE and/or on a charging limit variability of the EVSE, to bring the diversity parameter below the predetermined threshold.

3. The EVEMS of claim 1, comprising at least one circuit sensor configured to measure power currently being drawn by the electric circuit, wherein the power computation module is configured to subtract the measured power from the fixed maximum power when determining the available power to distribute among the plurality of EVSE.

4. The EVEMS of claim 3, wherein the power computation module is configured to apply a safety factor when determining the available power to distribute among the plurality of EVSE.

5. The EVEMS of claim 2, wherein the power distribution module is configured to distribute the available power as a function of the number of EV-connected EVSE and/or the battery state of connected vehicles in response to determining that the available power is insufficient.

6. The EVEMS of claim 2, wherein the power distribution module is configured to distribute the available power non-uniformly among the plurality of EVSE in response to determining that the available power is insufficient and/or that the diversity parameter is above the predetermined threshold.

7. The EVEMS of claim 6, wherein the power distribution module is configured to distribute the available power based on predicted demand, schedule and/or durations associated with each of the plurality of EVSE.

8. The EVEMS of claim 6, wherein the power distribution module is configured to distribute the available power to respect at least one defined condition comprising at least one of: minimizing peak power, minimizing charging time, obeying demand response command, obeying regulatory requirements, obeying emergency user orders, and obeying peak demand circumvention orders.

9. The EVEMS of claim 8, wherein the plurality of EVSE is divided in a plurality of zones, wherein the minimizing peak power and/or the minimizing charging time comprises one of: distributing the available power to one of the plurality of zones, and distributing the available power to more than one of the plurality of zones.

10. The EVEMS of claim 8, wherein the power distribution module comprises a machine learning model trained accept the state data as input and to generate at least one of a predicted demand, a schedule optimizing the at least one defined condition, and one or more predicted charging durations associated with each of the plurality of EVSE, and wherein the power distribution module is further configured to:
compute, by the at least one processor, from the one or more predicted charging durations, a corresponding authorized draw for each of the EV-connected EVSE, and
send, by the at least one communication device, a control signal to the EV-connected EVSE authorizing each EV-connected EVSE to operate at the corresponding authorized draw.

11. A method for controlling demand charge of a plurality of electric vehicle supply equipment (EVSE) connected to a common electric service entry providing a fixed maximum power to an electric circuit, the method comprising, at an electric vehicle energy management system (EVEMS):
computing a least a portion of the fixed maximum power corresponding to an available power to distribute among the plurality of EVSE;
computing a deployment parameter indicating a number of the plurality of EVSE that can operate according to a given operating condition based on the available power;
receiving, from each of the plurality of EVSE, state data comprising at least an indication of whether the corresponding EVSE is connected to an electric vehicle (EV);
computing a diversity parameter corresponding to a ratio between a number of EV-connected EVSE and the deployment parameter;
determining whether the available power is sufficient to power the EV-connected EVSE; and
distributing the available power among the EVSE based at least in part on the deployment parameter.

12. The method of claim 11, wherein distributing the available power among the EVSE comprises:
determining whether the available power is sufficient to power all the EV-connected EVSE according to the given operating condition;
in response to determining that the available power is sufficient and that the diversity parameter is below a predetermined threshold, sending a control signal to the plurality of EVSE authorizing each EVSE to operate according to the given operating condition;
in response to determining that the available power is insufficient, distributing the available power among the EVSE by sending a control signal to the EVSE authorizing each EVSE to operate below the given operating condition according to the available power; and
in response to determining that the diversity parameter is above the predetermined threshold, sending a control signal to distribute the available power among the EVSE as a function of the number of EV-connected EVSE, and/or based on a battery state of the EV connected to the EVSE and/or on a charging limit variability of the EVSE, to bring the diversity parameter below the predetermined threshold.

13. The method of claim 11, wherein determining the available power to distribute among the plurality of EVSE comprises measuring power currently being drawn by the electric circuit, and subtracting the measured power from the fixed maximum power.

14. The method of claim 13, wherein computing the available power comprises applying a safety factor.

15. The method of claim 12, wherein in response to determining that the available power is insufficient, the available power is distributed as a function of the number of EV-connected EVSE and/or the battery state of connected vehicles.

16. The method of claim 12, wherein in response to determining that the available power is insufficient and/or that the diversity parameter is above the predetermined threshold, the available power is distributed non-uniformly among the plurality of EVSE.

17. The method of claim 16, wherein the available power is distributed based on predicted demand, schedule, and/or durations associated with each of the plurality of EVSE.

18. The method of claim 16, wherein the available power is distributed to respect at least one defined condition comprising at least one of: minimizing peak power, minimizing charging time, obeying demand response command, obeying regulatory requirements, obeying emergency user orders, and obeying peak demand circumvention orders.

19. The method of claim 18, wherein the plurality of EVSE is divided in a plurality of zones, wherein the minimizing peak power and/or the minimizing charging time comprises one of: distributing the available power to one of the plurality of zones, and distributing the available power to more than one of the plurality of zones.

20. The method of claim 18, comprising:
providing the state data as input to a machine learning model trained to output at least one of a predicted demand, a schedule optimizing the at least one defined condition, and one or more predicted charging durations;
computing, from the one or more predicted charging durations, a corresponding authorized draw for each of the EV-connected EVSE; and
sending a control signal to the EV-connected EVSE authorizing each EV-connected EVSE to operate at the corresponding authorized draw.
